(19) United States
(12) Patent Application Publication
(10) Pub. No.: US 2017/0331205 A1
(43) Pub. Date: Nov. 16, 2017

(54) ELECTRICAL CONTACT ELEMENT, PRESS-IN PIN, BUSHING, AND LEADFRAME

(71) Applicant: HERAEUS DEUTSCHLAND GMBH & CO. KG, Hanau (DE)

(72) Inventors: Frank KRÜGER, Nidderau (DE); Gerald FREISE, Hanau (DE)

(73) Assignee: HERAEUS DEUTSCHLAND GMBH & CO. KG, Hanau (DE)

(21) Appl. No.: 15/531,150

(22) PCT Filed: Nov. 18, 2015
(86) PCT No.: PCT/EP2015/076911

§ 371 Date: May 26, 2017

(30) Foreign Application Priority Data
Nov. 27, 2014 (DE) 10 2014 117 410.0

(51) Int. Cl. H01R 12/58; H01R 12/70

(52) U.S. Cl. CPC H01R 12/585; H01R 12/7064

(57) ABSTRACT

An electrical contact element includes a base body and a coating covering the base body at least in sections. The coating includes an inner layer and an outer layer. The inner layer is applied to the base body and the outer layer is applied to the inner layer and forms a surface at least in sections of the electrical contact element. The inner layer is made of tin and the outer layer of silver, and the outer layer has a thickness of 50 nm-5.0 μm.

### BACKGROUND OF THE INVENTION

### 1. Field of the Invention

The invention is directed to an electrical contact element. In addition, the invention relates to a press-in pin that is pressed into a bushing. Moreover, the invention relates to a bushing into which the press-in pin is pressed. Furthermore, the invention relates to a leadframe or stamped frame.

### 2. Discussion of the Related Art

So-called press-fit contacts are known from the prior art. In the prior art, press-in pins are inserted into bushings or contacting recesses or contacting through-going openings. Press-fit contacts are usually coated with tin or tin alloys, wherein it is known that coatings of this type have a tendency to form whiskers. A whisker growth of this type is promoted above all in the presence of loadings, such as for example pressure loadings.

The current carrying capacity of whiskers is in the mA-range. Although it is possible in the case of higher currents that whiskers burn through, it is still possible for the flowing current to cause damage to components and/or cause malfunctions within the component even before such a burn-through occurs. Leaded solder is therefore used in order to avoid this type of formation of whiskers or it is used in the case of electronic applications where safety is of prime importance. Leaded materials of this type are however detrimental to health so that as far as possible leaded solder should not be used. The Guideline 2000/53/EC of the European Parliament and the Council regarding old vehicles stipulates banned substances and limits for substances for use in materials and components in motor vehicles. Accordingly, it is forbidden to use lead. The EU Guideline 2002/95/EC(RoHS 1) relating to limiting the use of certain hazardous substances in electric and electronic devices places for the most part a ban on the use of lead.

### SUMMARY OF THE INVENTION

The object of the present invention is to provide an electrical contact element that is less inclined to grow whiskers. A further object of the present invention is to provide a press-in pin that is pressed into a bushing, wherein this press-fit connection is to have a lowest possible tendency for whisker growth.

Furthermore, it is the object of the present invention to provide a bushing into which a press-in pin is pressed, wherein this press-in connection is likewise characterized by a small tendency to grow whiskers. In addition, it is the object of the present invention to further develop a leadframe or a stamped frame in such a manner that contacting recesses and/or contacting through-going openings are less inclined to grow whiskers.

Advantageous and expedient embodiments of the electrical contact element in accordance with the invention or of the leadframe in accordance with the invention or of the stamped frame are disclosed in the subordinate claims.

The electrical contact element in accordance with the invention comprises a base body and a coating that covers the base body at least in sections, wherein the coating comprises an inner layer and an outer layer, wherein the inner layer is applied to the base body and the outer layer is applied to the inner layer and forms at least in sections a surface of the electrical contact element, wherein the inner layer is formed from tin and the outer layer is formed from silver and the outer layer has a thickness of 50 nm to 5.0 μm.

Accordingly, the electrical contact element comprises at least a base body and in sections an additional coating, wherein the coating is formed from at least two coating layers. The base body can also be formed from multiple layers. Furthermore, the inner layer can be applied to a nickel layer. In other words, it is possible to provide an under layer of nickel to the additional coating.

The coating comprises at least one inner layer and an outer layer, wherein the outer layer forms at least in sections the surface of the electrical contact element. In other words, the inner layer of the coating is provided between the base body and the outer layer of the coating. The inner layer is formed from tin and the outer layer is formed from silver, wherein the outer layer of silver can have a thickness of 75 nm to 2.5 μm, in particular of 80 nm to 1.0 μm, in particular of 90 nm to 500 nm, in particular of 100 nm to 200 nm.

In relation to the base body and to the inner layer of tin, the outer layer of silver is very thin. Tin is a very soft metal. As the electrical contact element is pressed in or compressed with a further electrical contact element, the very thin outer layer of silver can be mechanically mixed or mixed through with the inner layer. An electrical contact element that has been compressed or contacted in this manner has significantly less tendency to grow whiskers.

It is even possible to describe the coating of the thin outer layer of silver with the inner layer of tin as a coating that has only a slight tendency to grow whiskers. In other words, the coating in accordance with the invention has the characteristic of tending to grow considerably fewer whiskers even in the non-compressed or non-pressed-in state. This is due to the formation of tin oxides. The formation of tin oxides is promoted by the merely thin outer layer of silver.

The inner layer is preferably pure tin, in other words is formed from tin with the fewest possible impurities. The outer layer is preferably formed from pure silver, in other words from silver with the fewest possible impurities.

The inner layer can have a thickness of 0.5 μm to 10.0 μm.

The electrical contact element comprises a contacting section for making electrical contact with a further electrical contact element. In the case of a press-in pin, it is possible for the contacting section to be a portion of the outer circumferential surface. In the case of the electrical contact element being embodied as an electrically conductive bushing, the contacting section can be the inner circumferential surface of a circular and/or elliptical and/or polygonal hollow cylindrical section.

The coating having an inner layer and an outer layer is provided at least in the contacting section of the electrical contact element. It is also possible that the coating completely covers the base body of the electrical contact element.

The base body of the electrical contact element can be formed from copper or a copper-based alloy, in particular from bronze, in particular from a copper-nickel-silicon alloy. In accordance with the invention, a first tin layer is applied to the base body that is formed from a copper-based alloy, wherein an outer, very thin layer of silver is provided on this inner layer of tin. In addition, it is possible to provide a nickel layer between the copper-based alloy and the first tin layer. The base body itself can be formed from one material or from multiple layers. It is thus possible that the base body comprises a layer of nickel on which preferably the inner layer of the coating is applied.

The inner layer and/or the outer layer are/is preferably deposited on the base body using a galvanic method.

The electrical contact element in accordance with the invention can be embodied as a press-in pin or a press-fit contact or as an electrically conductive bushing.

In accordance with a coordinate aspect, the invention relates to a press-in pin that is pressed into a bushing, wherein the press-in pin comprises a base body and a coating that covers the base body at least in sections, wherein the coating comprises an inner layer and an outer layer, and the inner layer is applied to the base body and the outer layer is applied to the inner layer, wherein the inner layer is formed from tin and the outer layer is formed from silver, wherein the outer layer and the inner layer are mixed with one another at least in sections as a result of being pressed into the bushing.

As a result of this type of mechanically mixing or mechanically commixing of the tin and silver particles of the inner layer and the outer layer, an electrical connection is formed between the press-in pin and the bushing and this electrical connection has a reduced tendency to grow whiskers. The mechanical mixing or mechanical commixing of the tin and silver particles of the inner layer and the outer layer occurs as a result of the prevailing pressure loading on the surface of the press-in pin as the press-in pin is pressed into the bushing. Since the outer layer of silver is very thin and the inner layer of tin is very soft, the mechanical mixing or mechanical commixing can be achieved by means of exerting pressure forces. In addition, it is conceivable to provide a lower layer of nickel to the coating. It is possible in connection with the lower layer of nickel that the base body of the press-in pin comprises a nickel layer to which the coating is applied.

In accordance with a further coordinate aspect, the invention relates to a bushing into which a press-in pin is pressed, wherein the bushing comprises a base body and a coating that covers the base body at least in sections, wherein the coating comprises an inner layer and an outer layer, and the inner layer is applied to the base body and the outer layer is applied to the inner layer, wherein the inner layer is formed from tin and the outer layer is formed from silver, wherein the outer layer and the inner layer are mixed with one another at least in sections as a result of the press-in pin being pressed in.

The bushing in accordance with the invention comprises an inner circumferential surface that delimits a hollow chamber section into which the press-in pin is pressed. The outer layer of silver thus forms at least in sections the surface of the bushing, wherein the outer layer and the inner layer are mixed with one another or commixed as a result of the press-in pin being pressed in. Accordingly, the tin material of the inner layer and the silver material of the outer layer are mixed with one another. The mechanical mixing or mechanical commixing of the tin and silver particles of the inner layer and the outer layer occurs as a result of the prevailing pressure loading on the surface of the bushing as the press-in pin is pressed into the bushing. It also applies in this connection that the mechanical mixing or mechanical commixing as a result of the very thin outer layer of silver and the soft inner layer of tin may be performed by means of exerting pressure forces. In addition, it is conceivable to provide a lower layer of nickel. It is possible in connection with the lower layer of nickel that the base body of the bushing comprises a nickel layer to which the coating is applied.

In a further coordinate aspect, the invention relates to a leadframe or a stamped frame, comprising at least one contacting recess or contacting through-going opening having an inner circumferential surface, which delimits the contacting recess or the contacting through-going opening, and a coating that covers at least in sections the inner circumferential surface, wherein the coating comprises an inner layer and an outer layer, wherein the inner layer is applied to the inner circumferential surface and the outer layer is applied to the inner layer and forms at least in sections a contacting area, wherein the inner layer is formed of tin and the outer layer is formed of silver and the outer layer has a thickness of 50 nm to 5.0 μm, in particular of 75 nm to 2.5 μm, in particular of 80 nm to 1.0 μm, in particular of 90 nm to 500 nm, in particular of 100 nm to 200 nm.

The inner layer of the coating is preferably formed from pure tin and/or the outer layer of the coating is formed from pure silver. Pure tin is a tin material that comprises the fewest possible impurities. Pure silver is a silver material that has the fewest possible impurities. In addition, it is possible to provide under the first tin layer a nickel layer in terms of a lower layer of nickel. In connection with the lower layer of nickel, it is possible that the contacting recess or the contacting through-going opening comprises a nickel layer to which the coating, in particular the inner layer of the coating, is applied.

The inner layer can have a thickness of 0.5 to 10.0 μm.

It is possible to incorporate electrical contact elements, such as for example press-in pins and/or screws and/or press-fit contacts and/or wires and/or solder points, into the coated contacting recess and/or the coated contacting through-going opening, wherein the coating comprises an inner and an outer layer. In connection with the leadframe in accordance with the invention and/or with the stamped frame in accordance with the invention, similar advantages are achieved as already disclosed in connection with the electrical contact element in accordance with the invention and/or with the bushing in accordance with the invention into which the press-in pin is pressed.

### BRIEF DESCRIPTION OF THE INVENTION

The invention is further explained hereinunder with the aid of exemplary embodiments and with reference to the attached drawings together with further details.

In the drawings:

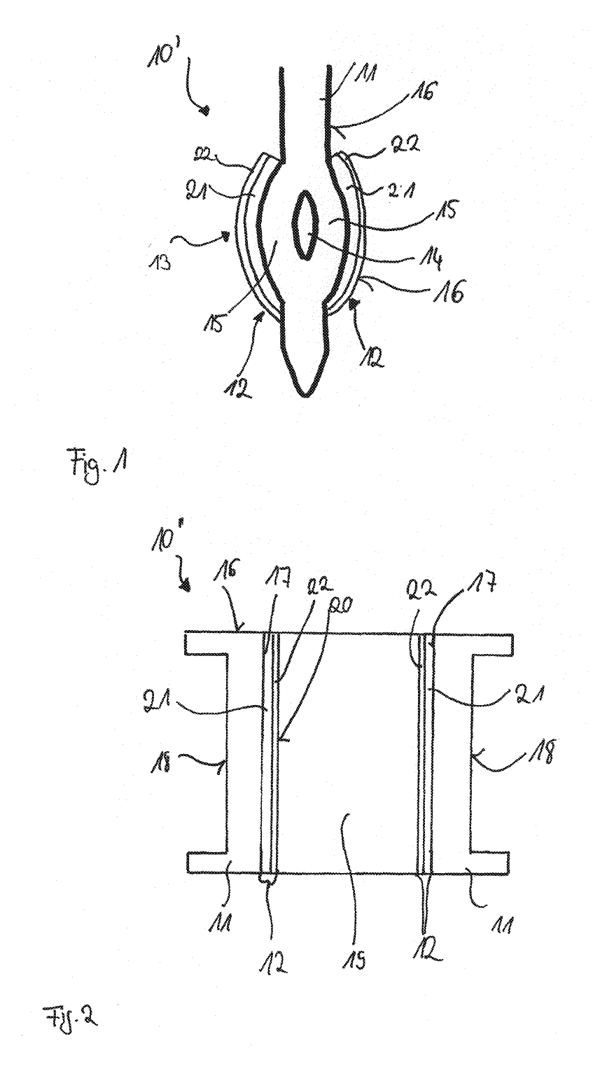

FIG. 1 illustrates an electrical contact element in accordance with the invention, embodied as a press-in pin;

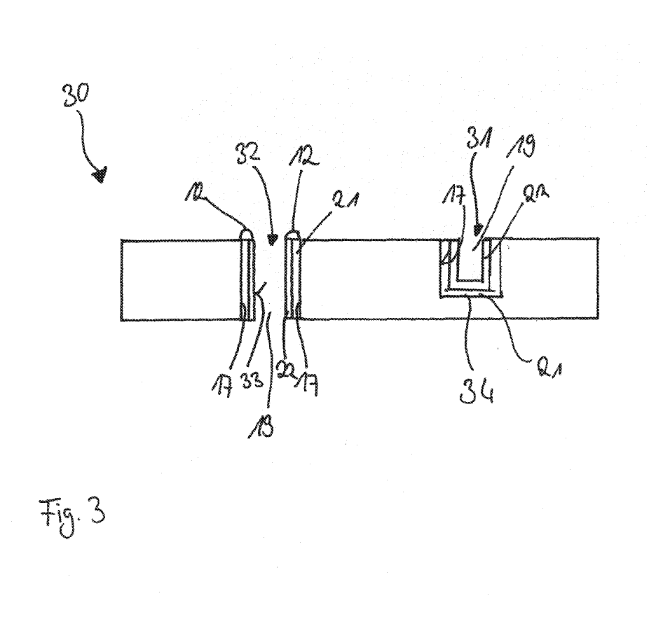

FIG. 2 illustrates an electrical contact element in accordance with the invention, embodied as an electrically conductive bushing; and

FIG. 3 illustrates a leadframe in accordance with the invention.

### DETAILED DISCUSSION OF THE INVENTION

Identical reference numerals are used hereinunder for like and like-functioning parts.

FIG. 1 illustrates an electrical contact element 10′ that is embodied as a press-in pin. The electrical contact element 10′ comprises a base body 11 having a press-in section 13 that is embodied in the form of two arms 15 that are separated by means of an intermediate space 14. The press-in section 13 is embodied in a flexible manner.

The base body 11 is covered in sections by a coating 12, wherein the coating 12 comprises an inner layer 21 and an outer layer 22. The inner layer 21 is applied to the base body 11 and the outer layer 22 is applied to the inner layer 21. The outer layer 22 of the coating 12 forms at least in sections a surface or portion of the surface 16 of the electrical contact element 10′. The illustrated thickness ratios of the coating 12 in relation to the base body 11 are provided merely for explanation purposes and are not to be regarded as being to scale.

The inner layer 21 is formed from pure tin and the outer layer 22 is formed from silver. The outer layer 22 comprises a thickness of 100 nm to 200 nm. The coating 12 is shown in the illustrated example only in the region of the press-in section 13. As an alternative, it is also possible for the coating 12 to completely cover the base body 11. The press-in section 13 is used as a contacting section for making electrical contact with a further electrical contact element, wherein in the present case the further electrical contact element is preferably a bushing or a contacting recess or a contacting through-going opening.

Furthermore, the press-in section 13 can comprise an under-layer of nickel so that a nickel layer is provided under the coating 12, in particular under the inner layer 21. The base body 11 can accordingly comprise in the press-in section 13 a nickel layer (not illustrated) and the inner layer 21 is applied to said nickel layer.

As the press-in pin 10′ is pressed in, the resultant prevailing pressure loading causes the thin outer layer 22 and the soft inner layer 21 to mix with one another at least in sections. Silver particles of the outer layer 22 are accordingly pressed into the inner layer 21. The formation of whiskers is prevented by virtue of the embodiment in accordance with the invention of the electrical contact element 10′.

The base body 11 is preferably formed from copper or from a copper-based alloy. In the sections of the electrical contact element 10′ that have not been provided with a coating 12, the surface 16 is formed by means of the base body 11 and its material.

The inner layer 21 and the outer layer 22 are applied using galvanic methods, preferably in a galvanic strip production system in which by way of example one stamped frame that is essentially strip-shaped in which the press-in pins are held in a state in which they are not yet fully stamped out is drawn through multiple successive cells.

FIG. 2 illustrates an electrical contact element 10″ in accordance with the invention that is embodied as an electrically conductive bushing. The electrical contact element 10″ comprises a base body 11 that has a hollow cylindrical shape. It likewise illustrates the inner circumferential surface 17 and the outer circumferential surface 18. It is possible to insert by way of example a press-in pin into the hollow chamber 19. The base body 11 is covered on the inner circumferential surface 17 completely or to its full circumferential extent by a coating 12, wherein the coating 12 comprises an inner layer 21 and an outer layer 22, wherein the inner layer 21 is applied to the base body 11, in particular to the inner circumferential surface 17 of the base body 11, and the outer layer 22 is applied to the inner layer 21. The outer layer 22 forms at least in sections a portion of the surface 16 of the electrical contact element 10″. The outer circumferential surface 18 is likewise embodied as a portion of the surface 16 of the electrical contact element 10″. In addition, it is conceivable to provide an under-layer of nickel to the coating 12. For this purpose, the base body 11 could comprise a nickel layer to which the coating 12 is applied.

The inner layer 21 is formed from pure tin and the outer layer is formed from silver, wherein the outer layer 22 has a thickness of 50 nm to 5.0 μm. So as to make electrical contact with a further electrical contact element, such as for example a press-in pin, the electrical contact element 10″ comprises a contacting section 20. In the present case, said contacting section is entirely the outermost layer of the coating 12 or of the electrical contact element 10″, said outermost layer being the layer that faces in the direction of the hollow chamber 19. The contacting section 20 is fully covered by the coating 12. As the press-in pin is pressed in, the thin outer layer 22 of silver and the soft inner layer 21 of tin are mixed with one another at least in sections as a result of the then prevailing pressure loading. Silver particles from the outer layer 22 are accordingly pressed into the inner layer 21. The formation of whiskers is prevented by virtue of the embodiment in accordance with the invention of the electrical contact element 10″.

FIG. 3 illustrates a leadframe 30 that is embodied in accordance with the invention. Said leadframe comprises a contacting recess 31 and a contacting through-going opening 32. Both the contacting recess 31 and also the contacting through-going opening 32 are delimited or formed by an inner circumferential surface 17. The inner circumferential surfaces 17 are in each case provided with a coating 12, wherein the coatings 12 comprise an inner layer 21 and an outer layer 22. The inner layers 21 are applied to the inner circumferential surfaces 17 and the outer layers 22 are applied to the inner layers 21.

In the non-coated state, the inner circumferential surfaces 17 of the contacting through-going opening 32 and the contacting recess 31 are formed by means of leadframe material. After having been coated, the outer layers 22 of the coatings 12 form the actual outermost layers of the contacting recess 31 and also of the contacting through-going opening 32, wherein the outermost layers are always understood to be those layers that form an outer surface in terms of a contacting area 33. The contacting areas 33 are accordingly formed in accordance with FIG. 3 in each case by the outermost layer 22 of the coating 12.

In the case of the contacting recess 31, it is furthermore possible to provide that the base 34 of the contacting recess 31 is likewise a coating 12 having an inner layer 21 and an outer layer 22. The inner layers 21 are formed from pure tin and the outer layers 22 are formed from silver.

It is to be mentioned at this point that all elements and components that are described above in connection with the embodiments in accordance with FIG. 1 to FIG. 3 when regarded individually or in any combination, in particular the details illustrated in the drawings, are claimed as essential for the invention.

### LIST OF REFERENCE NUMERALS

10′, 10″ Electrical contact element

11 Base body

12 Coating

13 Press-in section

14 Intermediate space

15 Arm

16 Surface

17 Inner circumferential surface

18 Outer circumferential surface

19 Hollow chamber

20 Contacting section

21 Inner layer

22 Outer layer

30 Leadframe

31 Contacting recess

32 Contacting through-going opening

33 Contacting area

34 Base

1. An electrical contact element comprising:
a base body comprising a base body section;
a coating covering the base body section, the coating comprising an inner layer and an outer layer,
the inner layer applied on the base body section, the inner layer comprising tin,
the outer layer applied on the inner layer and defining a surface of the electrical contact element the outer layer comprising silver and an outer layer thickness of 50 nm to 5.0 μm.

2. The electrical contact element as claimed in claim 1, wherein the outer layer thickness is 75 nm-2.5 μm.

3. The electrical contact element as claimed in claim 1, wherein the inner layer comprises pure tin or the outer layer comprises pure silver.

4. The electrical contact element as claimed in claim 1, wherein the inner layer comprises an inner layer thickness of 0.5 μm-10.0 μm.

5. The electrical contact element as claimed in claim 1,
further comprising a contacting section, the contacting section for making an electrical contact with a second electrical contact element,
wherein the coating is applied on the contacting section.

6. The electrical contact element as claimed in claim 1;
wherein the base body comprises copper, a copper based alloy, bronze, or a copper-nickel-silicon alloy.

7. The electrical contact element as claimed in claim 1; wherein the inner layer or the outer layer is a galvanic deposition layer.

8. The electrical contact element as claimed in claim 1,
wherein the base body comprises a nickel layer,
wherein the inner layer is applied on the nickel layer.

9. The electrical contact element as claimed in claim 1, wherein the electrical contact element is a press-in pin, a press-fit contact, or an electrically conductive bushing.

10. A press-in pin that for pressing into a bushing; the press-pin comprising:
a base body comprising a base body section;
a coating covering the base body section, the coating comprising an inner layer and an outer layer,
the inner layer applied to the base body section, the inner layer comprising tin,
the outer layer applied to the inner layer and defining a surface of the electrical contact element, the outer layer comprising silver; and
an intermix comprising the inner layer and the outer layer, the intermix resulting from pressing the press-in pin into the bushing.

11. A bushing for receiving a press-in pin, the hushing comprising:
a base body comprising a base body section;
a coating covering the base body section, the coating comprising an inner layer and an outer layer,
the inner layer applied to the base body section, the inner layer comprising tin,
the outer layer applied to the inner layer and defining a surface of the electrical contact element, the outer layer comprising silver; and
an intermix comprising the inner layer and the outer layer, the intermix resulting from pressing the press-in pin into the bushing.

12. A leadframe comprising:
a frame member defining a contacting recess or a contacting through-going opening, the frame member comprising an inner circumferential surface, the inner circumferential surface delimiting the contacting recess or the contacting through-going opening, and
a coating covering a section of the inner circumferential surface, the coating comprising an inner layer and an outer layer,
the inner layer applied on the section, the inner layer comprising tin,
the outer layer applied on the inner layer and defining a contacting area; the outer layer comprising silver and an outer layer thickness of 50 nm to 5.0 μm.

13. The leadframe as claimed in claim 12, wherein the outer layer thickness is 75 nm-2.5 μm.

14. The leadframe as claimed in claim 12, wherein the inner layer comprises pure tin or the outer layer comprises pure silver.

15. The leadframe as claimed in claim 12, wherein when the frame member is the contacting recess the contact recess comprising a base, the coating covering a portion of the base.

16. The electrical contact element as claimed in claim 1, wherein the outer layer thickness is 80 nm-1.0 μm.

17. The electrical contact element as claimed in claim 1, wherein the outer layer thickness is 90 nm-500 nm.

18. The electrical contact element as claimed in claim 1, wherein the outer layer thickness is 100 nm-200 nm.

19. The electrical contact element as claimed in claim 1, wherein the inner layer comprises pure tin.

20. The electrical contact element as claimed in claim 1, wherein the outer layer comprises pure silver.
